(19) United States
(12) Patent Application Publication
(10) Pub. No.: US 2011/0114707 A1
(43) Pub. Date: May 19, 2011

(54) Method for creating highly compliant thermal bonds that withstand relative motion of two surfaces during temperature changes using spacing structures

(75) Inventor: Gregory P. Matis, Santa Barbara, CA (US)

(73) Assignee: Santa Barbara Infrared, Santa Barbara, CA (US)

(21) Appl. No.: 12/592,134

(22) Filed: Nov. 19, 2009

(51) Int. Cl. B23K 1/20; B05D 3/10; C25D 5/00

(52) U.S. Cl. 228/203; 427/294; 205/114

(57) ABSTRACT

A method for making thermally conductive high aspect ratio large area contact between devices with different coefficients of thermal expansion. The method of the invention includes the creation or placement of sparse structures on at least one of two surfaces or between the surfaces to maintain enough thickness that an interposed bonding material remains sufficiently compliant that relative thermal motion of the two devices can occur without damage to the devices or the bond during changes in temperature.

### BACKGROUND OF THE INVENTION

1. Field of the Invention

This invention relates generally to the thermally conductive bonding of materials and more particularly thermally conductive bonding of materials that undergo temperature changes where said materials have different coefficients of thermal expansion.

2. Description of the Related Art

In some fields of optical and laser-electronics, and micro-electrical/mechanical devices the component size can be significantly large; e.g. greater than 625 mm². This is particularly true when dealing with arrayed devices such as imaging sensors, digital liquid crystal displays or attenuators, digital infrared emitters, laser diodes, and deformable mirrors that can be planar, have a curved or a polygonal surface.

Packaging a device typically requires a second component of adequate design and geometry to facilitate a device's operation and provide a means to integrate the device into a product. The device and package component are typically joined or bonded at some level. The bond is required to provide any or all of the following characteristics: mechanical adhesion, bond strength, thermal conductivity, and electrical conductivity; and not induce damage or affect required functionality of the device and package component while being exposed to environmental influences; specifically large changes in temperature during processing and operation.

When large parts are required to be joined using solders, epoxies, adhesives, or any two-phase materials, and thermal or electrical conductivity must be well maintained, the bond must be made such that the one part can expand or contract at a greater rate than the other one without damaging one or both of the parts and without disrupting the thermal or electrical conductivity of the bond during temperature changes that range from room temperature to cryogenic temperatures. The larger the area of the bond the greater the need for compliance in the bond as the induced thermal stress due to expansion mismatch in substrates becomes larger. This is especially needed when the temperature at which the bond was formed is far different than the temperature at which a device that includes the bond is operated; e.g., cryogenic temperatures.

Achieving an accurate bond thickness is essential to obtaining the desired interface stress state and maintaining desired geometrical and functional relationships of the device and its package. During the bonding process this task can be difficult to control due to complexities of the bond wetting, shrinkage of the bonding material, and general applied mass required to maintain device and package intimacy.

Known methods for reducing the induced stress/strain state of joined components include increasing the size of the gap or bond thickness. Depending on the elastic/plastic properties of the bonding material a certain level of success can be achieved using arrayed solder or adhesive bumps or columns, electroformed hinge contacts, or thick bonding layers. When the bonding area gets large, greater than 625 mm², and the required operational temperature range is greater than 300 K the bond thickness can range from tens to hundreds of microns. Arrayed bonding sites can be applied in large areas which reduces the likelihood of deformation of the device or package but due do the separated nature this approach does not offer the thermal transfer benefits of a continuous bond material.

Use of high strength bonding materials; e.g. AuSn, can reduce the likelihood of fatigue of the joint and offer excellent heat transfer; however high process temperatures for this material makes it unsuitable for joining temperature sensitive devices. Additionally due to the lack of plasticity of this bonding material, especially in large area bonds, the induced stress/strain, caused by the large temperature differential from bonding down to cryogenic and the general large area of the bond, is directed at the joined components fully which then must be designed for added strength or increased compliance. This can be costly and reduce device yields.

Popular bonding materials such as Pb, PbSn, leadfree solders, filled epoxies, and alloys of Bi, Sn, Cd, and Ga have poor cryogenic ductility and become brittle as high aspect ratio features or of large bond thickness. Indium or high indium content alloy solders exhibit exceptional ductility at cryogenic temperatures and large plasticity when subjected to high stress. Indium readily cold welds to itself and attaches to other surfaces if care is taken to address oxide formation; and can be processed at relatively low temperatures within the range typically experienced by sensitive electronic devices during final fabrication or operation. Candidate solders other than those with high percentages of indium formed in gaps greater than 50 microns are susceptible to significant creep and stress induced fracture at cryogenic temperatures.

Known methods for filling a precise gap using a solder preform includes a solder matrix having microparticles such as molybdenum secured within the solder matrix; ref U.S. Pat. No. 7,422,141. The microparticles are of different forms and self arrange during a solder bonding process so as to provide a uniform separation between opposing soldered surfaces.

One major drawback of this technique is that the solder matrix must be prepared in advance and cast as a preform. The ability to produce uniform preforms that are free standing and can maintain extremely uniform thicknesses using high ductility, oxide sensitive, indium solders is difficult and costly. This task is time-consuming and reduces yield. Secondly the temperature of preform and the surfaces to be joined must still be raised above the solder solidus to form a continuous bond which exposes the solder joint and the parts to the same stress/strain effects upon cooling.

Room temperature curing conductive adhesives, using a gap filler medium, expose the surfaces to be joined to significantly smaller temperature differentials reducing the aforementioned stress/strain effects. Unfortunately these adhesives or epoxies typically do not exhibit adequate adhesive strength at cryogenic temperatures when applied in thick layers or large areas without using an elevated temperature curing profile and/or significant mechanical or chemical roughening of the bondable surfaces. Additionally the heat transfer performance of these adhesive matrices are inferior to solder or two-phase alloys.

On the other hand, a known method of making tall accurate structures is referred to in the art as LIGA; ref Becker et al. This method involves lithography, electrodeposition (i.e., galvanoforming), and molding. According to this method, lithography is used to define patterns in polymer resist films. The patterns are then filled with metal by electrodeposition. While this method permits the formation of relatively large structures with high aspect ratios (10 to hundreds of microns tall and only a few microns wide), it does not allow the device complexity obtained by surface micromachining; or include the thermal and electrical conductivity benefits of a continuous adhesive bond.

Alternatively direct patterning and electrodeposition of structures on to semiconductor wafers has been described in detail in U.S. Pat. No. 7,271,022. In this reference lithography is used to produce windows in a resist material; these windows are filled with a metal and either with surface micromachining or using etching methods the height of these structures is accurately obtained. With proper choice of process and materials complex patterns and various densities of structures can be produced on a wide array of materials. While this method is the preferred method for producing accurate height structures on a micro-scale it does not combine the use of a bonding agent or material to facilitate the construction of a highly compliant, high heat transfer, and cryogenic capable adhesive joint.

In view of the foregoing, it would be desirable to provide a method of fabricating an accurate thickness bond between large area temperature sensitive devices and their packages that integrates the benefits of large scale high aspect ratio electrodeposited metal structures and the properties of highly compliant, cryogenic capable, thermally and/or electrically conductive bonding materials such that low stress/strain levels exist at the joined interfaces, high adhesive strength is achieved, a continuous or semi-continuous bond area is achieved, and parts and joint can be bonded at near ambient temperatures.

### REFERENCES

| Patent | Title | Author |
|---|---|---|
| 5,628,917 | Masking process for fabricating ultra- | MacDonald |
| | high aspect ratio, wafer-free micro-opto- | et al |
| | electromechanical structures | |
| 5,719,073 | Microstructures and single mask, single- | Shaw et al |
| | crystal process for fabrication thereof | |
| 5,725,729 | Process for micromechanical fabrication | Greiff et al |
| 5,846,849 | Microstructure and single mask, single- | Shaw et al |
| | crystal process for fabrication thereof | |
| 7,271,022 | Process for forming microstructures | Tang et al |
| 7,361,412 | Nanostructured soldered or brazed joints | Wang et al |
| | made with reactive multilayer foils | |
| 7,422,141 | Microparticle loaded solder preform | Pikulski |
| | allowing bond site control of device | |
| | spacing at micron, submicron, and | |
| | nanostructure scale | |
| 20070152016 | Solder foams, nano-porous solders, | Choe et al |
| | foamed-solder bumps in chip packages, | |
| | methods of assembling same, and systems | |
| | containing same | |

E. W. Becker, W. Ehrfeld, P. Hagmann, A. Maner and D. Muchmeyer-Fabrication of microstructures with high aspect ratios and great structural heights by synchrotron radiation lithography, gavanoforming, and plastic moulding (LIGA process)—Mar. 3, 1986.

### SUMMARY OF THE INVENTION

The present invention solves the above-described deficiencies by providing a uniform continuous/semi-continuous large area, thermal and electrical conductive, ambient temperature solder bond for electronic/optical-electronic devices and packaging with integral structural features to accurately control the bond thickness; and capable of accommodating thermal induced stress/strain effects of parts with dissimilar coefficients of thermal expansion over a wide temperature range, >300 K, exhibiting reliable cryogenic performance to 20 K and bonding adhesion.

### BRIEF DESCRIPTION OF THE DRAWINGS

The foregoing and other features, aspects and advantages of the present invention will become better understood with reference to the accompanying drawings in which:

FIG. 1—Assembled Component Bond Interface with Microstructural Features

FIG. 2—Thermal induced stress is proportional to bond area and expansion coefficient differential

FIGS. 3-9—are schematic views illustrating steps of an embodiment of the process of the invention for making an accurate thickness, highly compliant, continuous bond between two substrates at ambient temperature.

FIG. 10—Solder reflow and deposition

FIG. 11—Solder reflow and substrate joining

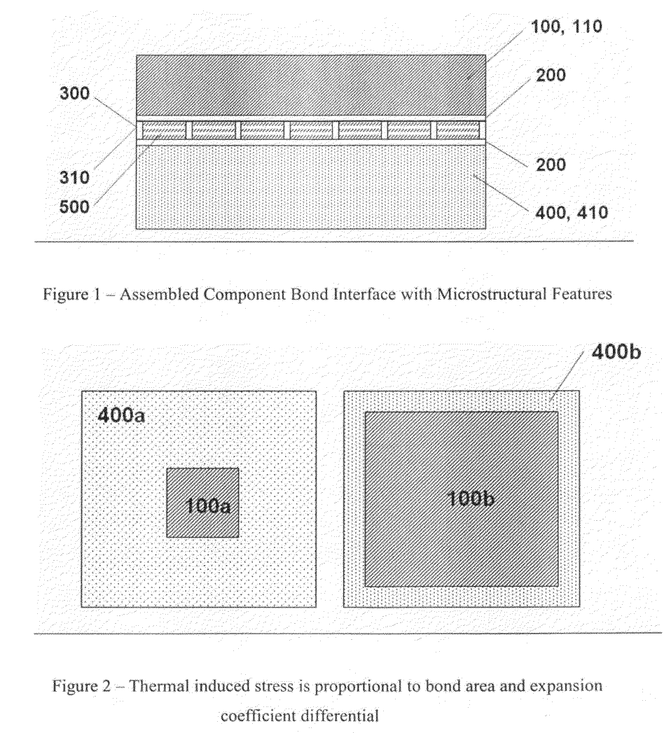

### DETAILED DESCRIPTION OF THE INVENTION

At the start of the process the substrates 100, 400 of selected materials are cleaned and prepared for application of the microstructure 300 which will determine part of the required bonding gap of the final assembly. In the trade numerous cleaning processes appropriate for the specific substrate have been developed by many sources and are applied accordingly.

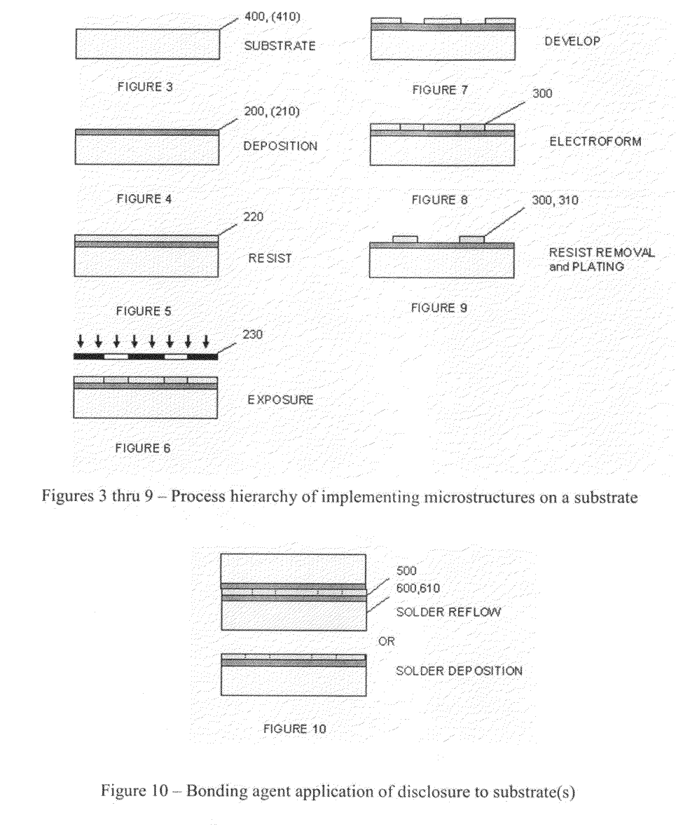

FIG. 3 shows a starting substrate 100, 400 on which to build the microstructure 300. The substrate 100, 400 may be any type of material, including but not limited to Si, Ge, GaAs, ceramics such as Al₂O₃, AlN, Si₃N₄, SiC, multi-layered co-fired ceramics (LTCC, HTCC), carbon, metals, metal composites, or glasses. The substrate 100, 400 may be a multi-layered co-fired ceramic substrate with built-in vias 110, 410 such that electrical conduction may be achieved from one part of the substrate to another surface on the substrate that is subsequently bonded. The vias 110, 410 are typically made from W, but other conductors such as Au, Cu, or Pt may be used. Substrates 100, 400, depending on function, may need to preserve thermal conduction characteristics in order to transfer heat effectively though a surface that is subsequently bonded.

In FIG. 4, a primary electrical and thermal conductive adhesion base layer 200 is deposited on one or both substrates 100, 400 to be subsequently joined by vacuum deposition/evaporation/sputtering or electroplating. Common base metallurgical compounds of Ti/Au, Ti/Ni/Au, Ti—W/Au, Cr/Au, Cr/Ni/Au are chosen to provide an appropriate adhesion layer for subsequent microstructure formation. The choice of appropriate adhesion base layer 200 compound is defined by specific substrate and microstructure materials, limiting process parameters, and desired functional characteristics of the bonded interface and the substrates; which typically have operating environment restrictions. In some embodiments the substrates 100, 400 do not require electrical conduction but require high thermal conduction properties. In this case prior to deposition of the adhesion base layer 200 a dielectric layer 210 is deposited of appropriate thickness and dielectric constant to achieve a design resistance. Once electrically isolated the surface to be bonded has the thermal conductive adhesion base layer 200 applied as described herein.

In FIG. 5, a photo-sensitive patternable material, resist 220, is applied to one or both surfaces of the substrates to be joined. A negative resist is typically chosen where negative patterns of the microstructure design are directly imaged into the photoresist layer as a window or aperture. The photoresist 220 is applied on top of the adhesion base layer 200 by spray, solution, or direct deposition. Following deposition the photoresist 220 is baked at a specified temperature to remove lighter fractions and stabilize the solids.

In FIG. 6, the patterns are transferred by transmitting radiation through a pattern mask 230 using lithographic processes. After photo-exposure the resist 220 is chemically altered to resist chemical dissolution. Areas that define the microstructure geometries are covered by the mask 230 and not exposed. These areas are subsequently developed and the unexposed resist is dissolved away leaving open windows or cavities into the resist 220 of the desired microstructure geometry down to the base adhesion layer 200. It is desired to achieve large aspect ratio features in the patterns. These can range from 50 to 300 microns in height. Conventional resists are typically used to produce features <25 microns so special formulations are used. Examples are Microchem KMPR-1000, Shipley BPR100, Clariant AZ50XT series, etc. In cases where the substrate topography is not continuous, resists such as Clariant AZ5000 series are preferred. Other suitable materials used in the micro-electronic material fabrication industry are polymethyl-methacrylate, or polyimide. Following resist 220 patterning the substrates 100, 400 are typically low-temperature baked to fix the resist 220.

FIG. 7 shows the substrates 100, 400 ready for deposition of the microstructure material 300. The preferred method is electro-deposition of a suitable metal compound, otherwise known in the trade as electroforming. One or both substrates are prepared by the caustic or acidic cleaning of the base adhesion layer 200. Masking or inherent protection of sensitive structures on the substrates by sacrificial materials is typically performed prior to electroforming. Electroforming is widely practiced in the electronics trade and details of such will not be detailed within this submission. In the present invention suitable materials for electroforming of microstructures 300 are Ni, Ni—Co, Rh, Pd, and Pt. Other commonly electroplated materials such as Au, Cu, Ag, and Al are not suitable for this invention due to their tendency to form complex intermetallics with the solder alloy 500 used in subsequent bonding thereby resulting in low interface reliability and brittleness of the bond at cryogenic temperatures. In one embodiment of this invention, a solder dam or continuous feature can be electroformed in the same process that the microstructures 300 are formed.

In FIG. 8, the electroforming process is run until the microstructures 300 design thickness is achieved and can typically be controlled within several microns from nominal without subsequent machining or planarization steps.

In FIG. 9 the substrates following electroforming are cleaned to remove trace plating residue and dried. The resist 220 is removed by ashing or dissolution in an appropriate solvent leaving the free standing electroformed metal microstructures 300 formed on the substrate 100, 400. The bottom surface of the substrates 100, 400 including the microstructures 300 has an immersion Au finish 310 applied by electro-deposition. The Au thickness is maintained at 0.1 microns.

In FIG. 10, both substrates 100, 400 have solder alloy 500 deposited in an inert atmosphere on the surfaces that are to be bonded. The solder alloy 500 is applied by methods of thermal reflow, vacuum deposition/evaporation, or electroplating. In the present invention the suitable materials for solder 500 are In, and In-alloys. In and In-alloy solders have strong affinity to form oxides which affects their surface wetting characteristics so special preparation of suitable forms or work surfaces is required if thermal reflow processes are preferred. In one embodiment of this invention, 200-1000 angstroms of a metal 610, Cr, is deposited on a suitable flat transfer substrate 600 of Si or Glass which is placed on a hot plate. The metal 610 minimally reacts with the solder 500 and thereby makes a good release agent during reflow. Alternatively vacuum deposition/evaporation and electroplating processes provide better control of the atmosphere, or lack thereof, reducing oxide contamination during deposition of the In solder 500. In one embodiment masks can be used during these deposition processes to control placement of the In solder 500 or vary its thickness as a function of area. These deposition processes can control thickness to tens of angstroms when fully optimized.

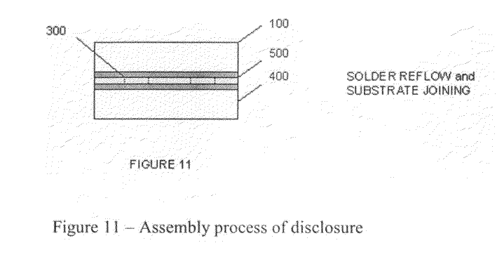

In FIG. 11, solder 500 of adequate volume applied to both substrates 100, 400 is melted in an inert atmosphere and either directly, or indirectly, a small amount of scrubbing is performed to ensure the In solder 500 fully wets the substrate 100, 400 surfaces and fills the available volume defined by the area of the substrate and thickness defined by the microstructures 300. The soldered substrates 100, 400 are rapidly cooled to below the solidus by transfer to a chill plate. Excess solder flash is removed from the substrates 100, 400 using contact tools and the substrates 100, 400 are separated from the transfer substrate leaving a continuous bondable In solder surface 500 of equivalent thickness to the microstructures 300 contained therein. In this embodiment the adhesive gap formed by the solder alloy 500 is accurately controlled by the height of the microstructures 300 formed on one or both substrates 100, 400.

What is claimed is:

1. A method for forming a thermally conductive bond between two surfaces, comprising:
patterning of at least one of said surfaces with raised structures;
placing a bonding medium between said surfaces;
contacting a first surface to a first side of said bonding medium;
contacting a second surface to second side of said bonding medium;
causing said bonding medium to flow between said surfaces; and,
causing the highest points of said raised structures to come into contact.

2. The method of claim 1, wherein a negative resist is used to produce said raised structures.

3. The method of claim 1, wherein the bonding medium is an Indium Alloy.

4. The method of claim 1 further comprising:
placing a conductive adhesion base layer on at least one surface.

5. The method of claim 4, wherein a negative resist is used to produce said raised structures.

6. The method of claim 4, wherein the bonding medium is an Indium Alloy.

7. The method of claim 4, wherein the conductive adhesion base layer is applied by vacuum deposition.

8. The method of claim 4, wherein the conductive adhesion base layer is applied by electroplating.
